(19) United States
(12) Patent Application Publication
(10) Pub. No.: US 2007/0199039 A1
(43) Pub. Date: Aug. 23, 2007

(54) System and method of receiving video content

(75) Inventors: Yolius Diroo, San Antonio, TX (US); Edward Walter, Boerne, TX (US); Steven M. Wollmershauser, San Antonio, TX (US); Michael Raftelis, San Antonio, TX (US)

Correspondence Address: TOLER SCHAFFER, LLP, 8500 BLUFFSTONE COVE, SUITE A201, AUSTIN, TX, 78759, US

(73) Assignee: SBC Knowledge Ventures, LP, Reno, NV (US)

(21) Appl. No.: 11/360,368

(22) Filed: Feb. 23, 2006

(51) Int. Cl. H04N 7/16; H04N 7/173; H04N 7/20

(52) U.S. Cl. 725/134; 725/142; 725/63; 725/131

(57) ABSTRACT

A system and method of receiving video content is disclosed. In a particular embodiment, the method includes receiving video content at a set-top box device via an access network. The method also includes writing the video content onto a removable secondary storage medium received at a secondary storage media interface of the set-top box device.

### FIELD OF THE DISCLOSURE

The present disclosure is generally related to receiving video content.

### BACKGROUND

Home entertainment provides viewers with a variety of movie and television programming. Often, users wish to record video content for later viewing. Users can store video content at a digital video recorder (DVR) or other internal memory of a set-top box device. Service providers have developed software to prevent consumers from downloading a movie from the internal memory to other storage devices that are connected to the set-top box device, in order to prevent unauthorized copying of recorded video content.

Once a user records video content to an internal memory of a set-top box device, the user typically cannot view the video content on any device other than a display device coupled to the set-top box device at which the video content was recorded. Moreover, restrictions designed to prevent set-top box theft can prevent the set-top box device from operating at any network connection other than the one at which it was originally installed. This prevents users from viewing video content in other rooms or locations. Hence, there is a need for an improved system and method of receiving video content.

### BRIEF DESCRIPTION OF THE DRAWINGS

FIG. 1 is a block diagram illustrating a particular embodiment of an Internet Protocol Television (IPTV) system configured to provide video content;

FIG. 2 is a block diagram illustrating a particular embodiment of a system to provide video content;

FIG. 3 is a block diagram illustrating a particular embodiment of a system to receive video content;

FIG. 4 is a block diagram illustrating a particular embodiment of a system to receive video content;

FIG. 5 is a flow diagram illustrating a particular embodiment of a method of receiving video content;

FIG. 6 is a flow diagram illustrating a second particular embodiment of a method of receiving video content;

FIG. 7 is a diagram illustrating a particular embodiment of a graphical user interface (GUI) to receive video content;

FIG. 8 is a diagram illustrating a second particular embodiment of a graphical user interface (GUI) to receive video content; and

FIG. 9 is a diagram of an illustrative embodiment of a general computer system.

### DETAILED DESCRIPTION OF THE DRAWINGS

A set-top box is disclosed and includes a processor and a memory device accessible to the processor. The set-top box also includes a plurality of secondary storage media interfaces. The memory device includes a video content writing module executable by the processor to write video content received at the set-top box device from an access network to a removable secondary storage medium received at one of the plurality of secondary storage media interfaces.

In another embodiment, a method of receiving video content is disclosed and includes receiving video content at a set-top box device via an access network. The method also includes writing the video content onto a removable secondary storage medium received at a secondary storage media interface of the set-top box device.

In another embodiment, a method of receiving video content is disclosed and includes receiving a removable secondary storage medium at a secondary storage media interface of a first set-top box device. The method also includes transmitting video content stored on the removable secondary storage medium to a display device coupled to the first set-top box device, where the video content was received from an access network and written to the removable secondary storage medium at a second set-top box device.

In another embodiment, a computer program embedded in a computer-readable medium is disclosed and includes instructions to write video content received at a set-top box device to a removable storage medium via one of a plurality of interfaces of the set-top box device.

In another embodiment, a computer program embedded in a computer-readable medium is disclosed and includes instructions to extract video content from a removable secondary storage medium via a secondary storage media interface of a first set-top box device, where the video content was written to the removable secondary storage medium at a second set-top box device. The computer program also includes instructions to transmit the video content to a display device coupled to the first set-top box device.

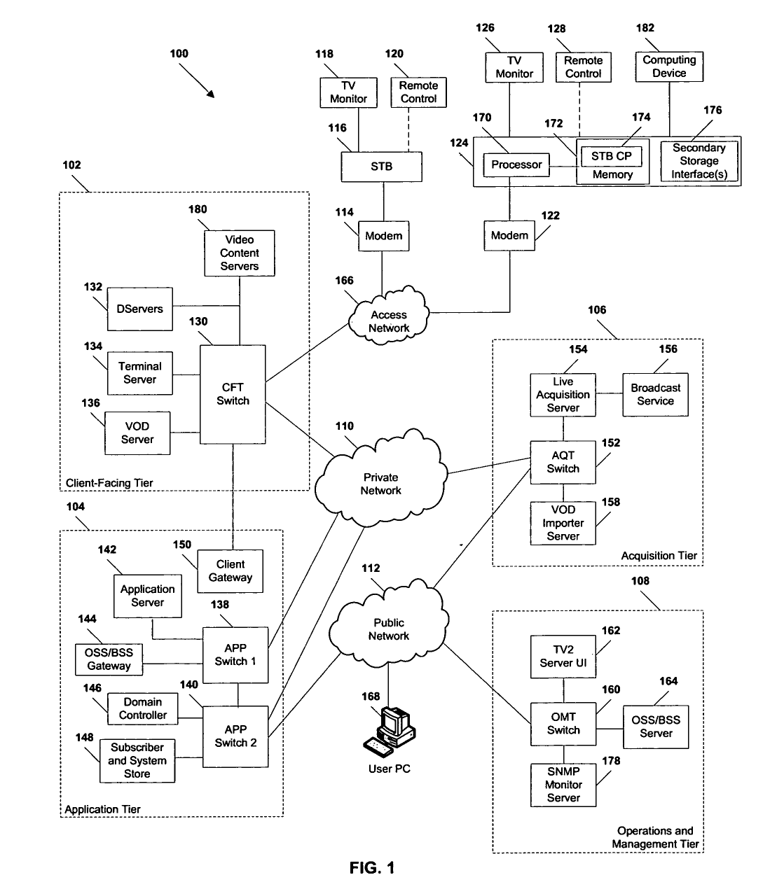

Referring to FIG. 1, an illustrative embodiment of an Internet Protocol Television (IPTV) system that may be used to provide video content is illustrated and is generally designated 100. As shown, the system 100 can include a client facing tier 102, an application tier 104, an acquisition tier 106, and an operations and management tier 108. Each tier 102, 104, 106, 108 is coupled to a private network 110; to a public network 112, such as the Internet; or to both the private network 110 and the public network 112. For example, the client-facing tier 102 can be coupled to the private network 110. Further, the application tier 104 can be coupled to the private network 110 and to the public network 112. The acquisition tier 106 can also be coupled to the private network 110 and to the public network 112. Additionally, the operations and management tier 108 can be coupled to the public network 112.

As illustrated in FIG. 1, the various tiers 102, 104, 106, 108 communicate with each other via the private network 110 and the public network 112. For instance, the client-facing tier 102 can communicate with the application tier 104 and the acquisition tier 106 via the private network 110. The application tier 104 can also communicate with the acquisition tier 106 via the private network 110. Further, the application tier 104 can communicate with the acquisition tier 106 and the operations and management tier 108 via the public network 112. Moreover, the acquisition tier 106 can communicate with the operations and management tier 108 via the public network 112. In a particular embodiment, elements of the application tier 104, including, but not limited to, a client gateway 150, can communicate directly with the client-facing tier 102.

As illustrated in FIG. 1, the client-facing tier 102 can communicate with user equipment via an access network 166, such as an Internet Protocol Television (IPTV) access network. In an illustrative embodiment, modems, such as a first modem 114 and a second modem 122 can be coupled to the access network 166. The client-facing tier 102 can communicate with a first representative set-top box device 116 via the first modem 114 and with a second representative set-top box device 124 via the second modem 122. The client-facing tier 102 can communicate with a large number of set-top boxes, such as the representative set-top boxes 116, 124, over a wide geographic area, such as a regional area, a metropolitan area, a viewing area, a designated market area or any other suitable geographic area, market area, or subscriber or customer group that can be supported by networking the client-facing tier 102 to numerous set-top box devices. In an illustrative embodiment, the client-facing tier 102, or any portion thereof, can be included at a video head-end office.

In a particular embodiment, the client-facing tier 102 can be coupled to the modems 114, 122 via fiber optic cables. Alternatively, the modems 114, 122 can be digital subscriber line (DSL) modems that are coupled to one or more network nodes via twisted pairs, and the client-facing tier 102 can be coupled to the network nodes via fiber-optic cables. Each set-top box device 116, 124 can process data received via the access network 166, via an IPTV software platform, such as Microsoft® TV IPTV Edition.

Additionally, the first set-top box device 116 can be coupled to a first external display device, such as a first television monitor 118, and the second set-top box device 124 can be coupled to a second external display device, such as a second television monitor 126. Moreover, the first set-top box device 116 can communicate with a first remote control 120, and the second set-top box device can communicate with a second remote control 128. The set-top box devices 116, 124 can include IPTV set-top box devices; video gaming devices or consoles that are adapted to receive IPTV content; personal computers or other computing devices that are adapted to emulate set-top box device functionalities; any other device adapted to receive IPTV content and transmit data to an IPTV system via an access network; or any combination thereof.

In an exemplary, non-limiting embodiment, each set-top box device 116, 124 can receive video content, which may include video and audio portions, from the client-facing tier 102 via the access network 166. The set-top boxes 116, 124 can transmit the video content to an external display device, such as the television monitors 118, 126. Further, the set-top box devices 116, 124 can each include a STB processor 170, a STB memory device 172, which is accessible to the STB processor 170. In one embodiment, a computer program, such as the STB computer program 174, can be embedded within the STB memory device 172. Each set-top box device 116, 124 can also include one or more secondary storage media interfaces 176, such as a flash memory card reader-writer, a memory stick interface, a disk drive, a universal serial bus (USB) interface, or any combination thereof. In a particular embodiment, the set-top box devices 116, 124 can communicate with a computing device 182 via a USB interface.

In an illustrative embodiment, the client-facing tier 102 can include a client-facing tier (CFT) switch 130 that manages communication between the client-facing tier 102 and the access network 166 and between the client-facing tier 102 and the private network 110. As shown, the CFT switch 130 is coupled to one or more data servers, such as D-servers 132, that store, format, encode; replicate, or otherwise manipulate or prepare video content for communication from the IPTV system 100 to the set-top box devices 116, 124. The CFT switch 130 can also be coupled to a terminal server 134 that provides terminal devices with a connection point to the private network 110. In a particular embodiment, the CFT switch 130 can also be coupled to a video-on-demand (VOD) server 136 that stores or provides VOD content imported by the IPTV system 100. In a particular embodiment, the CFT switch 130 can also be coupled to one or more video content servers 180. The video content server(s) 180 can include a cluster of video content servers, such as a group of multicast video content servers.

As illustrated in FIG. 1, the application tier 104 can communicate with both the private network 110 and the public network 112. The application tier 104 can include a first application tier (APP) switch 138 and a second APP switch 140. In a particular embodiment, the first APP switch 138 can be coupled to the second APP switch 140. The first APP switch 138 can be coupled to an application server 142 and to an OSS/BSS gateway 144. In a particular embodiment, the application server 142 can provide applications to the set-top box devices 116, 124 via the access network 166, which enable the set-top box devices 116, 124 to provide functions, such as display, messaging, processing of IPTV data and VOD material, etc. In a particular embodiment, the OSS/BSS gateway 144 includes operation systems and support (OSS) data, as well as billing systems and support (BSS) data. In one embodiment, the OSS/BSS gateway 144 can provide or restrict access to an OSS/BSS server 164 that stores operations and billing systems data.

Further, the second APP switch 140 can be coupled to a domain controller 146 that provides Internet access, for example, to users via the public network 112. For example, the domain controller 146 can provide remote Internet access to IPTV account information, e-mail, personalized Internet services, or other online services via the public network 112. Users can access such information or services using their personal computers 168. The second APP switch 140 can be coupled to a subscriber and system store 148 that includes account information, such as account information that is associated with users who access the system 100 via the private network 110 or the public network 112. Additionally, the second APP switch 140 can be coupled to one or more interactive voice response (IVR) servers 182 that can communicate with a user telephone 184 via the public network 112.

In a particular embodiment, the application tier 104 can also include a client gateway 150 that communicates data directly with the client-facing tier 102. In this embodiment, the client gateway 150 can be coupled directly to the CFT switch 130. The client gateway 150 can provide or restrict access to the private network 110 and the tiers coupled thereto.

In a particular embodiment, the set-top box devices 116, 124 can access the IPTV system 100 via the access network 166, using information received from the client gateway 150. In this embodiment, the access network 166 can provide security for the private network 110. User devices can access the client gateway 150 via the access network 166, and the client gateway 150 can allow such devices to access the private network 110 once the devices are authenticated or verified. Similarly, the client gateway 150 can prevent unauthorized devices, such as hacker computers or stolen set-top box devices from accessing the private network 110, by denying access to these devices beyond the access network 166.

For example, when the first representative set-top box device 116 accesses the system 100 via the access network 166, the client gateway 150 can verify subscriber information by communicating with the subscriber and system store 148 via the private network 110, the first APP switch 138, and the second APP switch 140. Further, the client gateway 150 can verify billing information and status by communicating with the OSS/BSS gateway 144 via the private network 110 and the first APP switch 138. In one embodiment, the OSS/BSS gateway 144 can transmit a query via the first APP switch 138, to the second APP switch 140, and the second APP switch 140 can communicate the query via the public network 112 to the OSS/BSS server 164. After the client gateway 150 confirms subscriber and/or billing information, the client gateway 150 can allow the set-top box device 116 to access IPTV content and VOD content. If the client gateway 150 cannot verify subscriber information for the set-top box device 116, e.g., because it is connected to an unauthorized twisted pair, the client gateway 150 can block transmissions to and from the set-top box device 116 beyond the access network 166.

As indicated in FIG. 1, the acquisition tier 106 includes an acquisition tier (AQT) switch 152 that communicates with the private network 110. The AQT switch 152 can also communicate with the operations and management tier 108 via the public network 112. In a particular embodiment, the AQT switch 152 can be coupled to a live acquisition server 154 that receives or acquires television or movie content, for example, from a broadcast service 156. In a particular embodiment, the live acquisition server 154 can transmit the television or movie content to the AQT switch 152, and the AQT switch 152 can transmit the television or movie content to the CFT switch 130 via the private network 110.

Further, the television or movie content can be transmitted to the D-servers 132, where it can be encoded, formatted, stored, replicated, or otherwise manipulated and prepared for communication to the set-top box devices 116, 124. The CFT switch 130 can receive the television or movie content from the D-servers 132 and communicate the content to the modems 114, 122 via the access network 166. The set-top box devices 116, 124 can receive the television or movie content via the modems 114, 122, and can transmit the television or movie content to the television monitors 118, 126. In an illustrative embodiment, video or audio portions of the television or movie content can be streamed to the set-top box devices 116, 124.

Further, the AQT switch can be coupled to a video-on-demand importer server 158 that stores television or movie content received at the acquisition tier 106 and communicates the stored content to the VOD server 136 at the client-facing tier 102 via the private network 110. Additionally, at the acquisition tier 106, the video-on-demand (VOD) importer server 158 can receive content from one or more VOD sources outside the IPTV system 100, such as movie studios and programmers of non-live content. The VOD importer server 158 can transmit the VOD content to the AQT switch 152, and the AQT switch 152, in turn, can communicate the material to the CFT switch 130 via the private network 110. The VOD content can be stored at one or more servers, such as the VOD server 136.

When users issue requests for VOD content via the set-top box devices 116, 124, the requests can be transmitted over the access network 166 to the VOD server 136, via the CFT switch 130. Upon receiving such requests, the VOD server 136 can retrieve the requested VOD content and transmit the content to the set-top box devices 116, 124 across the access network 166, via the CFT switch 130. The set-top box devices 116, 124 can transmit the VOD content to the television monitors 118, 126. In an illustrative embodiment, video or audio portions of VOD content can be streamed to the set-top box devices 116, 124.

FIG. 1 further illustrates that the operations and management tier 108 can include an operations and management tier (OMT) switch 160 that conducts communication between the operations and management tier 108 and the public network 112. In the embodiment illustrated by FIG. 1, the OMT switch 160 is coupled to a TV2 server 162. Additionally, the OMT switch 160 can be coupled to an OSS/BSS server 164 and to a simple network management protocol (SNMP) monitor 170 that monitors network devices within or coupled to the IPTV system 100. In a particular embodiment, the OMT switch 160 can communicate with the AQT switch 152 via the public network 112.

In an illustrative embodiment, the live acquisition server 154 can transmit the television or movie content to the AQT switch 152, and the AQT switch 152, in turn, can transmit the television or movie content to the OMT switch 160 via the public network 112. In this embodiment, the OMT switch 160 can transmit the television or movie content to the TV2 server 162 for display to users accessing the user interface at the TV2 server 162. For example, a user can access the TV2 server 162 using a personal computer (PC) 168 coupled to the public network 112.

In a particular embodiment, a user can issue a request to a set-top box device, such as the second representative set-top box device 124, to receive video content, for example, from the VOD server 136 or the video content servers 180. The set-top box processor 170 can be configured to transmit the request to the CFT switch 130. The set-top box device 124 can receive the video content via a modem 122, for example, and transmit the video content to a television monitor 126 that is coupled to the set-top box device 124. In another embodiment, the set-top box device 124 can receive the video content from a local area network (LAN) via a computing device coupled to a USB interface of the set-top box device 124. In another embodiment, the set-top box device 124 can receive still images from a computing device coupled to a USB interface of the set-top box device 124.

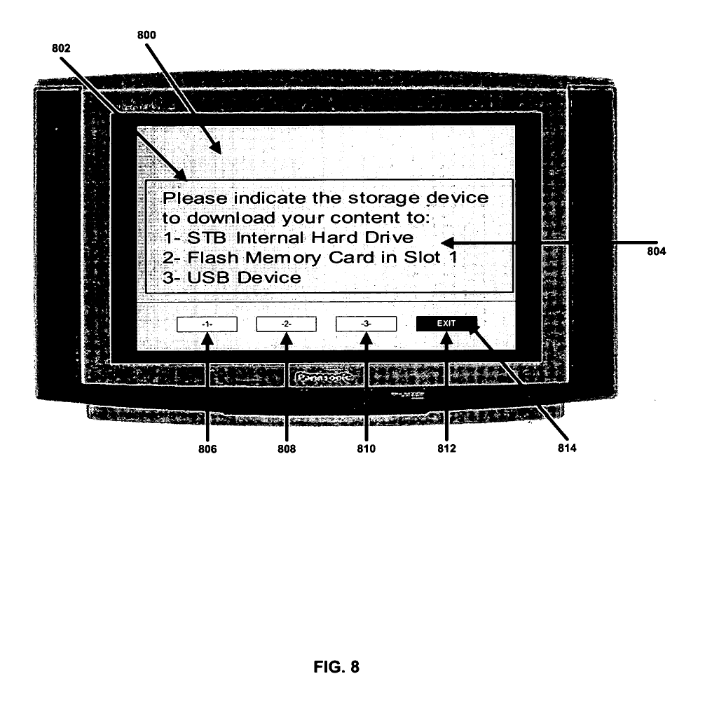

In a particular embodiment, the user can issue a command to the set-top box device 124 to write the video content to a removable secondary storage medium. The user can insert a removable secondary storage medium, such as a flash card memory device, into one of the secondary storage interfaces 176. Alternatively, where the secondary storage interfaces 176 include a USB interface, the user can couple an external memory device to the USB interface. In an illustrative embodiment, the set-top box device 124 can transmit a graphical user interface (GUI) to the television monitor 126 prompting the user to select an interface 176 at which the video content is to be written to the removable secondary storage medium. An example of a GUI to prompt the user to select an interface is illustrated in FIG. 8.

In one embodiment, the STB memory device 172 can include an installation module that is executable by the STB processor 170 to run an auto-install process to install the removable secondary storage medium, when the medium is received at a secondary storage interface 176. In an illustrative embodiment, the STB memory device 172 can also include a recognition module that is executable by the STB processor 170 to determine whether the removable secondary storage medium is compatible with a format of video content received at the set-top box device 124. In another illustrative embodiment, the STB memory device 172 can include a memory availability module that is executable by the STB processor 170 to determine whether any memory is available on the removable secondary storage medium to store the video content.

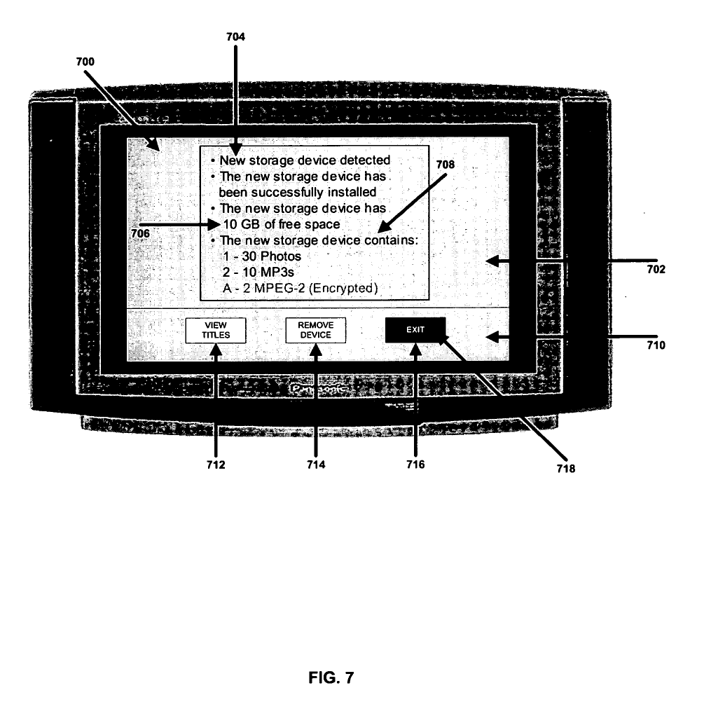

In a particular embodiment, the set-top box device 124 can include one or more indicator screens, each of which is configured to display the amount of memory available on a removable secondary storage medium received at a secondary storage interface 176 of the set-top box device 124. In another embodiment, the set-top box device 124 can display available memory and contents of a removable secondary storage medium via a GUI, such as the GUI illustrated in FIG. 7.

If the set-top box device 124 determines that a removable secondary storage medium received at one of its secondary storage interfaces 176 is compatible with video content received by the set-top box device 124 and contains available memory, the set-top box 124 can write the video content 124 to the removable secondary storage medium. In a particular embodiment, the video content can be encrypted to prevent copying to another removable secondary storage medium. Further, the video content can include a time stamp or a log of how many times the video content is view, either of which can be readable by the set-top box device 124 to determine whether the video content has expired and should no longer be played back. In another embodiment, the video content can include no expiration mechanism.

In another particular embodiment, the set-top box device 124 can receive a command to play back video content stored on a removable secondary storage medium. The set-top box device 124 can receive a removable secondary storage medium that stores video content written to the removable secondary storage medium at the set-top box device 124 or at a second set-top box device 116. In an illustrative embodiment, the set-top box device 124 can execute an auto-install process when it receives the removable secondary storage medium. Further, the set-top box device 124 can also execute a recognition process to determine whether the removable secondary storage medium stores video content that is compatible with a format of video content playable at the set-top box device 124.

If the set-top box device 124 installs the removable secondary storage medium and determines that the video content stored on the removable secondary storage medium is of a format playable by the set-top box device 124, the set-top box device can extract the video content from the removable secondary storage medium and transmit the video content to the television monitor 126. In a particular embodiment, if the removable secondary storage medium contains a plurality of titles of video content, the set-top box device 124 can transmit a GUI containing the plurality of titles to the television monitor 126. The set-top box device 124 can receive a selection of a title from the user via the GUI.

In a particular embodiment, the set-top box device 124 can read a time stamp stored with selected video content. The set-top box device 124 can determine based on the time stamp whether an expiration period associated with the video content has elapsed. If the expiration period has not elapsed, the set-top box device 124 can transmit the video content to the television monitor 126. Conversely, if the expiration period has elapsed, the set-top box device 124 can transmit a message to the television monitor 126 or an indicator screen of the set-top box device 124 that indicates that the video content is no longer available for playback.

In another particular embodiment, the set-top box device 124 can read a log stored with the video content, which indicates a number of times that the video content has been played back. The set-top box device 124 can determine based on the log whether the video content has expired. If the number of times that the video content has been played back exceeds a threshold number of times, the set-top box device can transmit a message to the television monitor 126 or an indicator screen of the set-top box device 124 that indicates that the video content is no longer available for playback. On the other hand, if the number of times that the video content has been played back does not exceed a threshold number of times, the set-top box device 124 can transmit the video content to the television monitor 126.

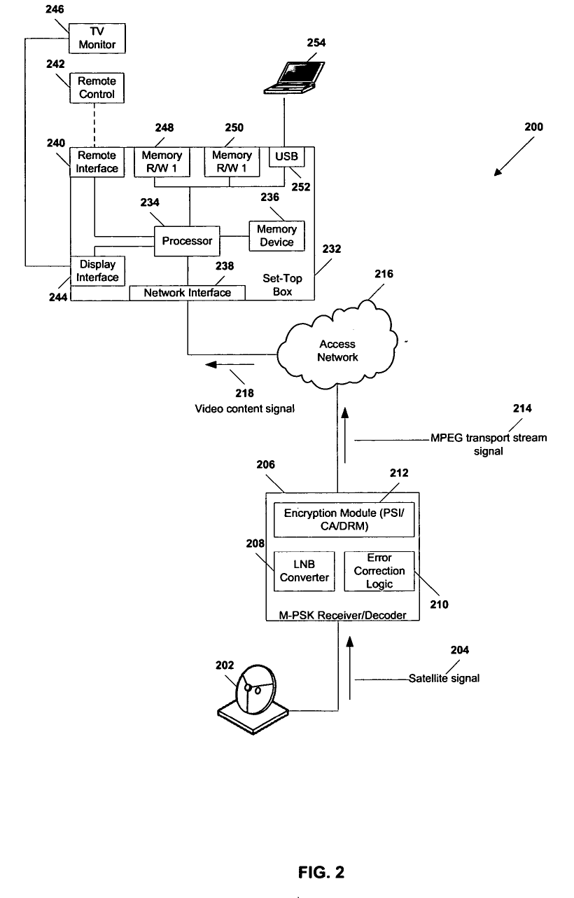

Referring to FIG. 2, a particular embodiment of a system to provide video content is illustrated and is generally designated 200. As shown, the system 200 includes a satellite dish 202. The satellite dish 202 is coupled to a receiver/decoder 206. In a particular embodiment, the receiver/decoder 206 can include a low-noise blockdown (LNB) converter 208, error correction logic 210, an encryption module 212, or any combination thereof. The receiver/decoder 206 can be configured to transmit video content to subscriber devices such as a set-top box device 232 via a private access network 216.

In a particular embodiment, the satellite dish 202 can receive a satellite signal 204 and transmit the signal 204 to the receiver/decoder 206. The satellite signal 204 can be, for example, a M-phase shift keying PSK (M-PSK) signal, and the receiver/decoder 206 can be a M-PSK receiver/decoder. In an illustrative embodiment, the satellite signal 204 can be received at the dish via C-band transport frequencies (3700 MHz-4200 MHz) or Ku-band transport frequencies (11,700 MHz-22,200 MHz), and the receiver/decoder 206 can convert the satellite signal 204 to L-band transport frequencies (500 MHz-2500 MHz) via the LNB converter 208.

The receiver/decoder 206 decodes the satellite signal 204 to produce a video content signal. For example, the receiver/decoder 206 can produce a digital MPEG transport stream signal 214. In an illustrative, non-limiting embodiment, the receiver/decoder 210 can detect errors in the digital MPEG transport stream signal 214 and correct the errors using the error correction logic 210. The error correction logic 205 can include forward error correction (FEC) hardware logic, instructions, or any combination thereof, at the receiver/decoder 206.

The receiver/decoder 206 is configured to transmit the digital MPEG transport stream signal 214 to the access network 216. In a particular embodiment, the receiver/decoder 206 can be configured to encrypt the digital MPEG transport stream signal 214 via the encryption module 212, prior to transmitting the signal 214 to the access network 216. The encryption module 212 can include hardware logic, instructions, or any combination thereof, to add a conditional access (CA) portion, a digital rights management (DRM) portion, a program system information (PSI), or any combination of the above, to the digital MPEG transport stream signal 214.

In a particular embodiment, the digital MPEG transport stream signal 214 can be transmodulated or otherwise altered or formatted to produce a video content signal 218 that is ultimately transmitted to a set-top box device 232 via the access network 216. For example, the digital MPEG transport stream signal 214 can be transmitted to a 8/16 vestigial sideband (VSB) modulator that produces a VSB signal carrying the video content.

The set-top box device 232 can receive the video content signal 218 via the private access network 216. In a particular embodiment, the set-top box device 232 can receive the video content signal 218 via a set-top box network interface 238 that communicates with a set-top box processor 234. The set-top box processor 234 can be coupled to a set-top box memory device 236 that includes instructions executable by the processor 234 to process the video content signal 218; communicate with a display device 246; communicate with a computing device 254; write video content to a removable secondary storage medium; play back video content stored on a removable secondary storage medium; to implement other functions, determinations, or prompts; or any combination thereof. The set-top box device 232 can be coupled to a television monitor 246 via a set-top box display interface 244 that communicates with the set-top box processor 234. Additionally, the set-top box processor 234 can be coupled to a set-top box remote interface 240, through which the processor 234 receives commands from a remote control device 242.

In a particular embodiment, the set-top box device 232 can include a first secondary storage interface 248 and a second secondary storage interface 250, such as flash card reader-writer devices. Additionally, the set-top box device 232 can include a universal serial bus (USB) interface 252 that can communicate with external storage devices, computing devices, or any combination thereof, such as a laptop computer 254.

In a particular embodiment, a user can issue a request to the set-top box device 232 to receive video content from the satellite dish 202 via the access network 216. The set-top box processor 234 can be configured to transmit the request to the access network 216. The set-top box device 232 can receive the video content signal 218 via the network interface 238, a modem, a tuner, other customer premises equipment, or any combination thereof, and transmit the video content to the television monitor 246.

In a particular embodiment, the user can issue a command to the set-top box device 232 to write the video content to a removable secondary storage medium. The user can insert a removable secondary storage medium, such as a flash card memory device, into one of the secondary storage interfaces 248-250. Alternatively, the user can couple an external memory device to the USB interface 252. In an illustrative embodiment, the set-top box device 232 can transmit a graphical user interface (GUI), such as that illustrated in FIG. 8, to the television monitor 246 prompting the user to select an interface 248-252 at which the video content is to be written to the removable secondary storage medium.

If the set-top box device 232 determines that a removable secondary storage medium received at one of its secondary storage interfaces 248-252 is compatible with video content received by the set-top box device 232 and contains available memory, the set-top box 232 can write the video content carried by the video content signal 218 to the removable secondary storage medium. In a particular embodiment, the video content can be encrypted to prevent copying to another removable secondary storage medium. Further, the video content can include a time stamp or a log of how many times the video content is view, either of which can be readable by the set-top box device 232 to determine whether the video content has expired and should no longer be played back. In another embodiment, the video content can include no expiration mechanism.

In another particular embodiment, the set-top box device 232 can receive a command to playback video content stored on a removable secondary storage medium. The set-top box device 232 can receive a removable secondary storage medium that stores video content written to the removable secondary storage medium at the set-top box device 232 or at another set-top box device. If the set-top box device 232 successfully installs the removable secondary storage medium and determines that the video content stored on the removable secondary storage medium is of a format playable by the set-top box device 232, the set-top box device can extract the video content from the removable secondary storage medium and transmit the video content to the television monitor 246. In a particular embodiment, if the removable secondary storage medium contains a plurality of titles of video content, the set-top box device 232 can transmit a GUI containing the plurality of titles to the television monitor 246. The set-top box device 232 can receive a selection of a title from the user via the remote control device 242, for example. If the set-top box device 232 determines that the video content includes no expiration period, or that the expiration period has not elapsed, the set-top box device 232 can transmit the video content to the television monitor 246.

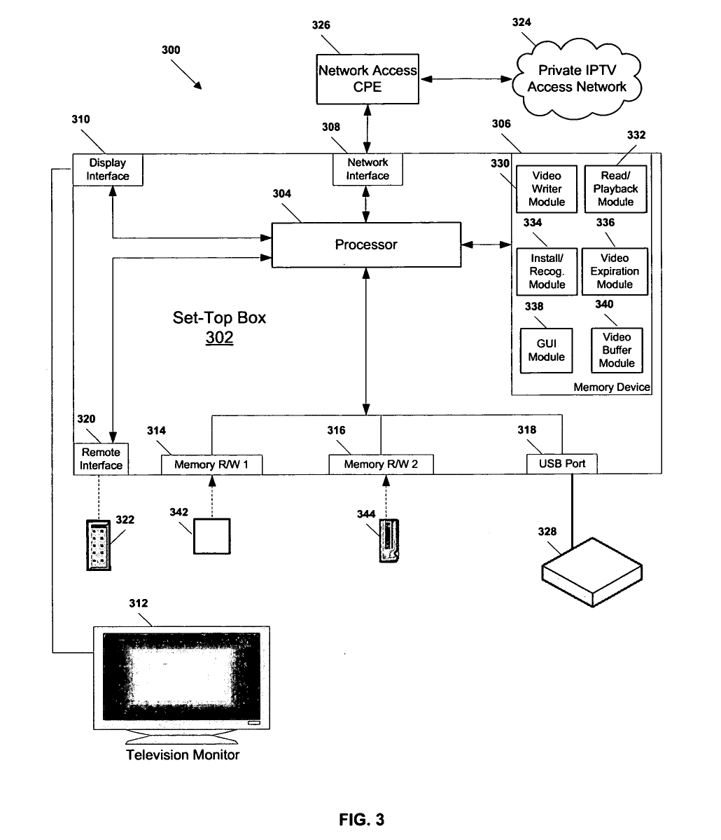

Referring to FIG. 3, an embodiment of a system to receive video content is illustrated and designated generally at 300. The system includes a set-top box device 302 that contains a processor 304 and a memory device 306 that is accessible to the processor 304. Additionally, the processor 304 is coupled to a network interface 308. Further, the processor 304 can be coupled to a display interface 310, such as a television interface, through which the set-top box device 302 can communicate video content, prompts, graphical user interfaces (GUIs), or other content to an external display device, such as a television monitor 312. In addition, the processor 304 can communicate with a remote control device 322, via a remote control interface 320.

The processor 304 can communicate with an external access network, such as an Internet Protocol Television (IPTV) access network 324, via the network interface 308. In an illustrative, non-limiting embodiment, the IPTV access network 324 can be the access network 166 illustrated in FIG. 1. In a particular embodiment, network access customer premises equipment (CPE) 326 can facilitate communication between the network interface 308 and the IPTV access network 324. The network access CPE 326 can include a router, a local area network device, a modem, such as a digital subscriber line (DSL) modem, any other suitable device for facilitating communication between the network interface 308 of the set-top box device 302 and the IPTV access network 324, or any combination thereof. In an illustrative, non-limiting embodiment, the network access CPE 326 can be the modem 114 or 122 illustrated in FIG. 1.

In a particular embodiment, the processor 304 can communicate with a plurality of secondary storage interfaces, such as a first secondary storage interface 314, a second secondary storage interface 316, a universal serial bus (USB) interface 318, or any combination thereof. Each secondary storage interface 314-318 is configured to enable the processor 304 to receive video content from and write video content to a removable secondary storage medium, such as a flash memory card 342, a memory stick 344, or an external hard drive device 328.

In a particular embodiment, the memory device 306 can include a video writer module 330. The video writer module 330 can be executable by the processor 304 to receive and process a video content request from a user, for example, via the remote control device 322. The video writer module 330 can also be executable by the processor 304 to write the video content to a removable secondary storage medium received at or coupled to the secondary storage interfaces 314-318, in response to a command from the user to write the video content to the removable secondary storage medium. The video writer module 330 can also be executable by the processor 304 to prompt the user to select an interface 314-318 at which the video content is to be written to the removable secondary storage medium.

The memory device 306 can include a read/playback module 332 that is executable by the processor 304 to receive and process a request to play back video content stored on a removable secondary storage medium from a user. In a particular embodiment, the read/playback module 332 can be executable by the processor 304 to extract video content from the removable secondary storage medium and transmit the video content to the television monitor 312 via the display interface 310. In another particular embodiment, the read/playback module 332 can be executable by the processor 304 to prompt the user to select from a plurality of titles or collections of video content stored on the removable secondary storage medium.

Further, the memory device 306 can include an installation/recognition module 334 executable by the processor 304 to run an auto-install process to install a removable secondary storage medium received at a secondary storage interface 314-318. In an illustrative embodiment, the installation/recognition module 334 can be executable by the processor 304 to determine whether the removable secondary storage medium is compatible with a format of video content received at the set-top box device 302 that is to be written to the removable secondary storage medium. Additionally, the installation/recognition module 334 can be executable by the processor 304 to determine whether any memory is available on the removable secondary storage medium to store the video content. In another illustrative embodiment, the installation/recognition module 334 can be executable by the processor 304 to determine whether any memory is available on the removable secondary storage medium to determine whether video content stored on the removable secondary storage medium is compatible with a format of video content playable by the set-top box device 302.

In an illustrative embodiment, the memory device 306 can include a video expiration module 336 executable by the processor 304 to determine whether video content stored on a removable secondary storage medium has expired or contains no expiration mechanism. For example, the video expiration module 336 executable by the processor 304 to read a time stamp stored with selected video content and to determine based on the time stamp whether an expiration period associated with the video content has elapsed. Alternatively, the video expiration module 336 executable by the processor 304 to read a log stored with the video content, which indicates a number of times that the video content has been played back and to determine based on the log whether the video content has expired. If the video content has expired, the set-top box device 302 can transmit a message to the television monitor 312 or an indicator screen of the set-top box device 302 that indicates that the video content is no longer available for playback.

In a particular embodiment, the memory device 306 can include a graphical user interface (GUI) module 338 executable by the processor 304 to generate GUIs related to prompts, indicators, messages, menus and other graphical items, and to transmit such graphical items to the television monitor 312, to indicator screens of the set-top box device 302, or any combination thereof.

The memory device 306 can also include a video content control and buffer module 338 that is executable by the processor 304 to receive video content requested by a user and to buffer the video content before transmitting it to the display interface 310, in order to prevent underflow.

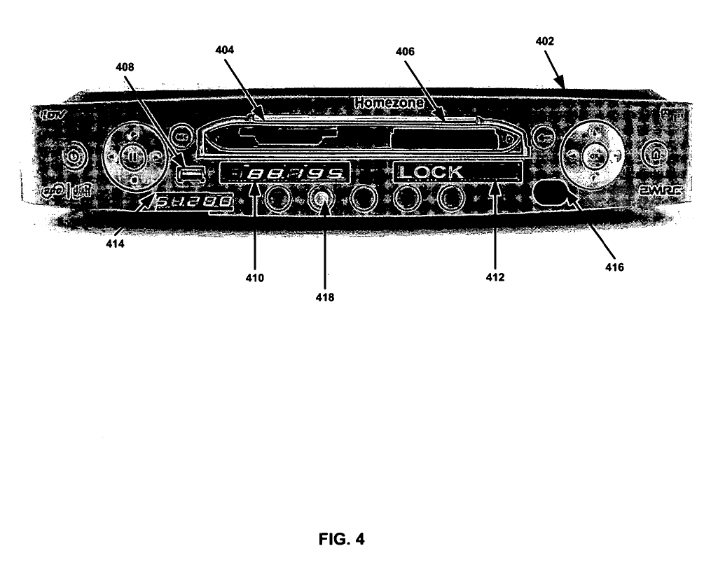

Referring to FIG. 4, an embodiment of a set-top box device 402 configured to receive, write and play back video content is illustrated. In a particular embodiment, the set-top box device 402 can include a plurality of secondary storage interfaces, such as a first flash card reader-writer 404, a second flash card reader-writer 406, a universal serial bus (USB) interface 408, or any combination thereof. Each secondary storage interface 404-408 is configured to enable the set-top box device 402 to receive video content from and write video content to a removable secondary storage medium.

In an illustrative embodiment, the set-top box device 402 can include a plurality of indicator screens 410-414. Each indicator screen can display information or data related to one of the secondary storage interfaces 404-408. For example, each indicator screen 410-414 can display an amount of available memory, or that memory is insufficient, on a removable secondary storage medium received at one of the secondary storage interfaces 404-408. Further, each indicator screen 410-414 can display an indicator related to a locked status of a removable secondary storage medium, when a user attempts to copy video content stored on the removable secondary storage medium to another removable secondary storage medium. In another embodiment, each indicator screen 410-414 can display a record status, play status, currently playing title, or any combination thereof, with respect to one of the secondary storage interfaces 404-408. Additionally, each indicator screen 410-414 can display a message indicating that video content stored on a removable secondary storage medium has expired. Moreover, each indicator screen 410-414 can display a prompt to provide a removable secondary storage medium at one of the secondary storage interfaces 404-408.

In addition, the set-top box device 402 can communicate with a remote control device, via a remote control interface 416. In an illustrative embodiment, the set-top box device 402 can include one or more buttons 418 that users can depress or manipulate to toggle manually among the secondary storage interfaces 404-408.

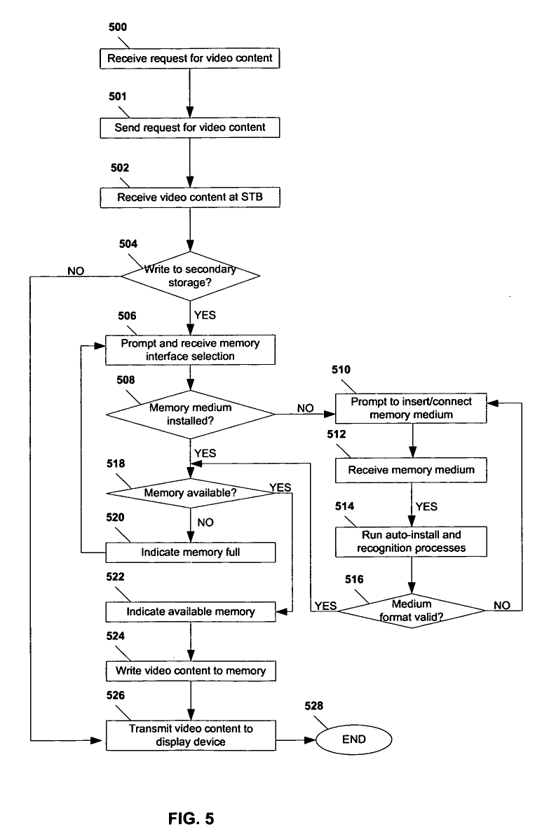

Referring to FIG. 5, a particular embodiment of a method of receiving video content is illustrated. At block 500, a set-top box device receives a request for video content from a user. In an illustrative embodiment, the set-top box device can receive the request from a remote control device in the form of a channel change request, video-on-demand request, or other request to view video content at a display device coupled to the set-top box device. Moving to block 501, the set-top box sends a request for the video content, for example, to a server via an IPTV or satellite access network. Continuing to block 502, the set-top box receives the requested video content.

Proceeding to decision step 504, the set-top box can determine whether it has received a command to write the video content to a removable secondary storage device. If the set-top box does not receive a command to write the video content to a removable secondary storage device, the method proceeds to block 526, and the set-top box transmits the video content to a display device coupled to the set-top box. The method then terminates at 528. Conversely, if the set-top box receives a command to write the video content to a removable secondary storage device, the method continues to block 506. At block 506, the set-top box can prompt the user to select a secondary storage interface, such as a USB interface, an internal hard drive, or a flash memory card reader-writer. In an illustrative embodiment, the set-top box can transmit a graphical user interface (GUI) that prompts the user to select a secondary storage interface from a plurality of secondary storage interfaces. An example of such a GUI is illustrated in FIG. 8.

Advancing to decision step 508, the set-top box determines whether a removable secondary storage medium is received at the selected interface. For example, the set-top box can determine whether an external storage device is coupled to the USB interface or a flash memory card is inserted at a flash memory card reader-writer. If a memory device is received at the selected interface, the method moves to decision step 516. Conversely, if a memory device is not received at the selected interface the method proceeds to block 510, and the set-top box prompts the user to provide a removable secondary storage medium at the selected interface. The set-top box can prompt the user via a GUI at the display device or via an indicator screen at the set-top box.

Moving to block 512, the set-top box receives the removable secondary storage medium at the selected interface. In a particular embodiment, the method proceeds to block 514, and the set-top box can run an auto-install/recognition process to install the memory device at the selected interface and to determine whether the removable secondary storage medium includes a valid format, i.e., a format that is compatible with video content received at the set-top box. Continuing to decision step 516, the set-top box determines whether the format of the removable secondary storage medium is valid. If the removable secondary storage medium format is not valid, the method can return to block 510, and the set-top box can prompt the user for another removable secondary storage medium. On the other hand, if the removable secondary storage medium format is valid, the method proceeds to decision step 518.

At decision step 518, the set-top box determines whether memory is available on the removable secondary storage medium to store the video content. If sufficient memory is not available, the method moves to block 520, and set-top box indicates that the removable secondary storage medium is full or does not contain enough available memory to store the video content. The method can then return to block 506. In an illustrative embodiment, the set-top box can display a “FULL” or “INSUFFICIENT MEMORY” indicator at the display device or an indicator screen at the set-top box.

Returning to decision step 518, in an illustrative embodiment, if sufficient memory is available, the method moves to block 522, and the set-top box can display the available memory via an indicator screen at the set-top box device. Proceeding to block 524, the set-top box writes the video content to the removable secondary storage medium. Additionally, at block 526, the set-top box can transmit the video content to the display device. The method terminates at 528.

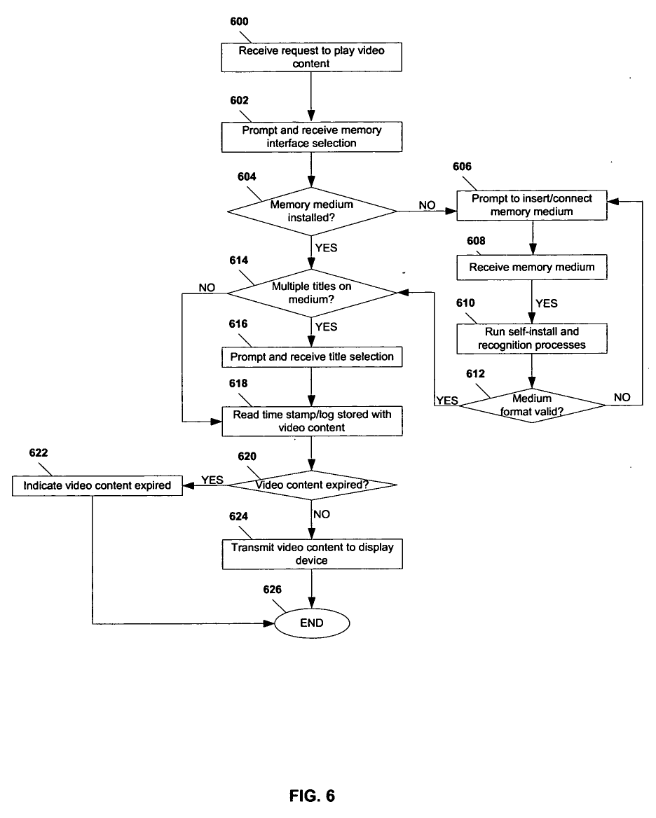

Referring to FIG. 6, a second particular embodiment of a method of receiving video content is illustrated. At block 600, a set-top box device receives a request for video content from a user. In an illustrative embodiment, the set-top box device can receive the request from a remote control device. At block 602, the set-top box can prompt the user to select a secondary storage interface, such as a USB interface, an internal hard drive, or a flash memory card reader-writer. In an illustrative embodiment, the set-top box can transmit a graphical user interface (GUI) that prompts the user to select a secondary storage interface from a plurality of secondary storage interfaces.

Advancing to decision step 604, the set-top box determines whether a removable secondary storage medium is received at the selected interface. For example, the set-top box can determine whether an external storage device is coupled to the USB interface or a flash memory card is inserted at a flash memory card reader-writer. If a memory device is received at the selected interface, the method moves to decision step 614. Conversely, if a memory device is not received at the selected interface the method proceeds to block 606, and the set-top box prompts the user to provide a removable secondary storage medium at the selected interface. The set-top box can prompt the user via a GUI at the display device or via an indicator screen at the set-top box.

Moving to block 608, the set-top box receives the removable secondary storage medium at the selected interface. In a particular embodiment, the method proceeds to block 610, and the set-top box can run an auto-install/recognition process to install the memory device at the selected interface and to determine whether the removable secondary storage medium includes video content in a valid format, i.e., a format that is playable at the set-top box. Continuing to decision step 612, the set-top box determines whether the format of the removable secondary storage medium is valid. If the removable secondary storage medium format is not valid, the method can return to block 606, and the set-top box can prompt the user for another removable secondary storage medium. On the other hand, if the removable secondary storage medium format is valid, the method proceeds to decision step 614.

At decision step 614, the set-top box determines whether multiple titles or collections of video content are stored on the removable secondary storage medium. If only one title is stored on the removable secondary storage medium, the method moves to block 618. Whereas, if multiple titles or collections of video content are stored on the removable secondary storage medium, the method advances to block 616, and the set-top box prompts the user, via a GUI, for example, to select from the plurality of titles or collections of video content stored on the removable secondary storage medium. The method then continues to block 618.

In a particular embodiment, at block 618, the set-top box can read a time stamp or log stored with the video content on the removable secondary storage medium. Proceeding to decision step 620, the set-top box can determine, based on the time stamp or log, whether the video content is expired. If the video content is expired, the method moves to block 622, and the set-top box displays an indicator that the video content is expired, and the method terminates at 626. Conversely, if the set-top box determines that the video content has not expired, the method advances to block 624, and the set-top box transmits the video content to a display device coupled to the set-top box device, and the method terminates at 626.

Though the aspects of the disclosed methods have been presented in a certain order, for ease of description, certain portions of the methods may be performed in a different order or simultaneously.

Referring to FIG. 7, a particular embodiment of a graphical user interface (GUI) to receive video content is illustrated and designated generally at 700. The GUI 700 can include a secondary storage media contents region 702 that can include, for example, an indication 704 that a removable secondary storage medium has been detected and successfully installed. The secondary storage media contents region 702 can include an indication 706 of available memory on the removable secondary storage medium. Further, the storage media contents region 702 can include a list 708 of contents stored on the removable secondary storage medium.

In a particular embodiment, the GUI 700 can include a command region 710 that displays selectable option indicators, such as soft buttons 712-716. In an illustrative embodiment, the command region 710 can include a first selectable option indicator 712 that a user can select to view titles of video content stored by the removable secondary storage medium. In another illustrative embodiment, the command region 710 can include a second selectable option indicator 714 that a user can select to remove or de-install the removable secondary storage medium. In another illustrative embodiment, the command region 710 can include a third selectable option indicator 716 that a user can select to exit to a previous GUI or to television programming. In an exemplary embodiment, a user can select among the selectable option indicators 712-716 by moving a highlight bar 718 by using arrow keys on a remote control and by pressing an ‘OK,’ ‘ENTER,’ ‘SELECT,’ or similar key when the desired indicator is highlighted.

Referring to FIG. 8, a particular embodiment of a graphical user interface (GUI) to receive video content is illustrated and designated generally at 800. The GUI 800 can include a secondary storage interface selection region 802 that displays a list 804 of selectable secondary storage interfaces, such as an internal drive of the set-top box, a flash memory card in a flash memory card reader-writer, a device coupled to a universal serial bus (USB) port of the set-top box, or any combination thereof.

In a particular embodiment, the GUI 800 can include selectable option indicators, such as soft buttons 806-812. In an illustrative embodiment, the GUI 800 can include a first selectable option indicator 806 that a user can select to choose a first selection from the list 814 of selectable interfaces. In another illustrative embodiment, the GUI 800 can include a second selectable option indicator 808 that a user can select to choose a second selection from the list 814 of selectable interfaces. In another illustrative embodiment, the GUI 800 can include a third selectable option indicator 810 that a user can select to choose a third selection from the list 814 of selectable interfaces. In another illustrative embodiment, the GUI 800 can include a fourth selectable option indicator 812 that a user can select to exit to a previous GUI or to television programming. In an exemplary embodiment, a user can select among the selectable option indicators 806-812 by moving a highlight bar 814 by using arrow keys on a remote control and by pressing an ‘OK’ or ‘ENTER’ key when the desired indicator is highlighted.

In conjunction with the configuration of structure described herein, the system and method disclosed allow a user of a set-top box device to store video content on removable secondary storage media received at the set-top box device. Additionally, the system and method disclosed provide a means for users to play back such video content at multiple set-top box devices, including set-top boxes other than the one at which the video content was written to the removable secondary storage medium. Hence, a user need not transfer a set-top box device to another room or location in order to view video content stored at a digital video recorder (DVR) or other internal memory of the set-top box device. Instead, the user can simply transfer the removable secondary storage medium. In a particular embodiment, the secondary storage interfaces can include a universal serial bus (USB) interface that allows the set-top box device to store video content at a computing device or an external storage device or to receive video content from a computing device or an external storage device.

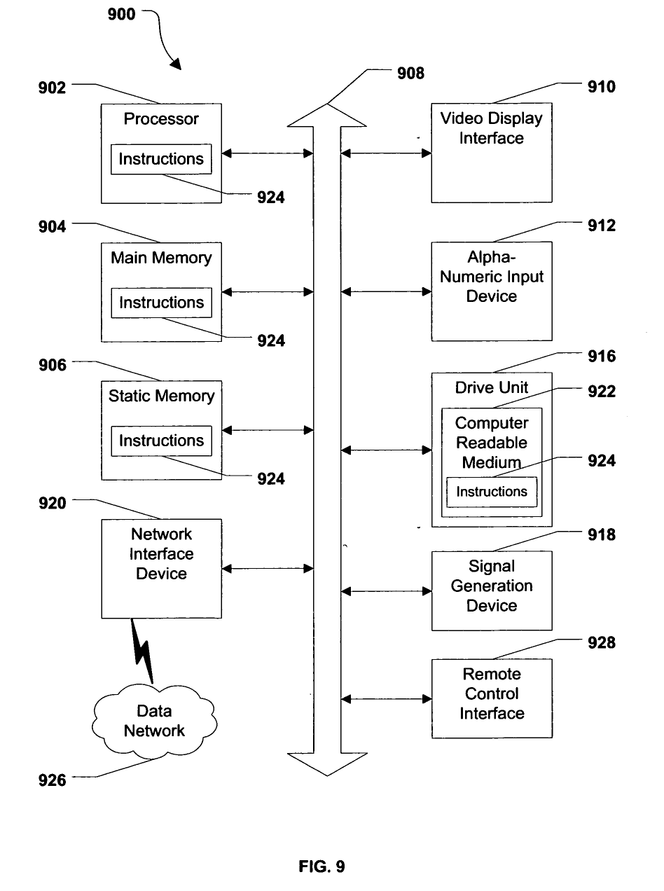

Referring to FIG. 9, an illustrative embodiment of a general computer system is shown and is designated 900. The computer system 900 can include a set of instructions that can be executed to cause the computer system 900, or a portion thereof, to perform any one or more of the methods or computer based functions disclosed herein. The computer system 900, or any portion thereof, may operate as a standalone device or may be a hardware or software module within a server or other device, as illustrated in FIGS. 1-2.

The computer system 900 can also be implemented as or incorporated into various other devices, such as the set-top box devices illustrated in FIGS. 1-4, or any other machine capable of executing a set of instructions (sequential or otherwise) that specify actions to be taken by that machine. In a particular embodiment, the computer system 900 can be implemented using electronic devices that provide audio, video or data communication. Further, while a single computer system 900 is illustrated, the term “system” shall also be taken to include any collection of systems or sub-systems that individually or jointly execute a set, or multiple sets, of instructions to perform one or more computer functions.

As illustrated in FIG. 9, the computer system 900 may include a processor 902, e.g., a central processing unit (CPU), a graphics-processing unit (GPU), or both. Moreover, the computer system 900 can include a main memory 904 and a static memory 906 that can communicate with each other via a bus 908. As shown, the computer system 900 may further include a video display unit 910, such as a liquid crystal display (LCD), an organic light emitting diode (OLED), a flat panel display, a solid state display, or a cathode ray tube (CRT). Additionally, the computer system 900 may include an input device 912, such as a remote control input, an input control panel, a keyboard, a mouse, a gaming station input, or one or more keys disposed on a set-top box device. The computer system 900 can also include a disk drive unit 916, or other secondary storage interface configured to receive a removable secondary storage medium. The computer can also include a signal generation device 918, and a network interface device 920.

In a particular embodiment, as depicted in FIG. 9, the disk drive unit 916 may include a computer-readable medium 922 in which one or more sets of instructions 924, e.g. software, can be embedded. Further, the instructions 924 may embody one or more of the methods or logic as described herein. In a particular embodiment, the instructions 924 may reside completely, or at least partially, within the main memory 904, the static memory 906, and/or within the processor 902 during execution by the computer system 900. The main memory 904 and the processor 902 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 924 or receives instructions 924 responsive to a propagated signal, so that a device connected to a network 926 can communicate audio, video or data over the network 926. Further, the instructions 924 may be transmitted or received over the network 926 via the network interface device 920.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of receiving video content, the method comprising:
receiving video content at a set-top box device via an access network; and
writing the video content onto a removable secondary storage medium received at a secondary storage media interface of the set-top box device.

2. The method of claim 1, further comprising receiving the video content from a satellite dish via the access network.

3. The method of claim 1, further comprising receiving the video content from an Internet Protocol Television (IPTV) system via the access network

4. The method of claim 1, further comprising receiving the video content from a local area network (LAN) via a data interface of the set-top box device.

5. The method of claim 1, wherein the removable secondary storage medium is an external memory device coupled to a universal serial bus interface of the set-top box device.

6. The method of claim 1, further comprising transmitting the video content to a display device coupled to the set-top box device.

7. The method of claim 1, further comprising prompting a user to select the secondary storage media interface, wherein the set-top box device includes a plurality of secondary storage media interfaces.

8. The method of claim 1, further comprising executing a self-install process to install the received removable secondary storage medium.

9. The method of claim 8, further comprising executing a recognition process to determine a compatibility of the removable secondary storage medium with a format of the video content.

10. A method of receiving video content, the method comprising:
receiving a removable secondary storage medium at a secondary storage media interface of a first set-top box device; and
transmitting video content stored on the removable secondary storage medium to a display device coupled to the first set-top box device, wherein the video content was received from an access network and written to the removable secondary storage medium at a second set-top box device.

11. The method of claim 10, wherein the first set-top box device and the second set-top box device are the same set-top box device.

12. The method of claim 10, further comprising:
executing a self-install process to install the removable secondary storage medium; and
executing a recognition process to determine compatibility of the removable secondary storage medium with a video content format playable by the first set-top box device.

13. The method of claim 10, further comprising prompting a user to select one of a plurality of video content titles stored on the removable secondary storage medium.

14. The method of claim 10, wherein the display device is a display portion of a computing device coupled to a universal serial bus interface of the first set-top box device.

15. The method of claim 10, further comprising:
reading a time stamp of the video content;
determining whether an expiration period has elapsed based on the time stamp; and
not playing the video content after the expiration period has elapsed.

16. The method of claim 10, further comprising:
determining a number of times that the video content has been viewed, wherein the number of times is stored on the removable secondary storage medium with the video content; and
not playing the video content when the number of times exceeds a threshold number.

17. The method of claim 16, further comprising:
playing the video content when the number of times does not exceed the threshold number; and
incrementing the number of times.

18. A set-top box device, comprising:
a processor and a memory device accessible to the processor; and
a plurality of secondary storage media interfaces, wherein the memory device includes a video content writing module executable by the processor to write video content received at the set-top box device from an access network to a removable secondary storage medium received at one of the plurality of secondary storage media interfaces.

19. The set-top box device of claim 18, wherein the video content is encrypted.

20. The set-top box device of claim 18, wherein the plurality of secondary storage media interfaces include at least one flash memory card reader-writer interface.

21. The set-top box device of claim 20, wherein the at least one flash memory card reader-writer interface is configured to receive a plurality of flash memory cards having different sizes.

22. The set-top box device of claim 20, wherein the plurality of secondary storage media interfaces include at least one universal serial bus (USB) interface.

23. The set-top box device of claim 22, wherein the removable storage medium includes an external memory device coupled to the USB interface.

24. The set-top box device of claim 20, further comprising a plurality of indicator screens, wherein each of the plurality of indicator screens displays an available memory of a removable storage medium received at one of the plurality of secondary storage media interfaces.

25. The set-top box device of claim 20, wherein the plurality of secondary storage media interfaces include at least one stick memory interface.

26. The set-top box device of claim 20, further comprising a toggle button configured to select a different one of the plurality of secondary storage media interfaces each time the toggle button is selected.

27. A computer program embedded in a computer-readable medium, the computer program comprising instructions to write video content received at a set-top box device to a removable storage medium via one of a plurality of interfaces of the set-top box device.

28. The computer program of claim 27, further comprising instructions to determine whether stored video content on a storage medium is expired and instructions to transmit the stored video content to a display device coupled to the set-top box device when the stored video content is not expired.

29. A computer program embedded in a computer-readable medium, the computer program comprising:
instructions to extract video content from a removable secondary storage medium via a secondary storage media interface of a first set-top box device, wherein the video content was written to the removable secondary storage medium at a second set-top box device; and
instructions to transmit the video content to a display device coupled to the first set-top box device.
